(19) United States
(12) Patent Application Publication
(10) Pub. No.: US 2013/0189495 A1
(43) Pub. Date: Jul. 25, 2013

(54) Nanoscale Photolithography

(71) Applicants: Peng-Fei Fu, Midland, MI (US); Lingjie Jay Guo, Ann Arbor, MI (US); Eric Scott Moyer, Midland, MI (US); Carlos Pina-Hernandez, Berkeley, CA (US)

(72) Inventors: Peng-Fei Fu, Midland, MI (US); Lingjie Jay Guo, Ann Arbor, MI (US); Eric Scott Moyer, Midland, MI (US); Carlos Pina-Hernandez, Berkeley, CA (US)

(73) Assignee: The Regents of the University of Michigan, Ann Arbor, MI (US)

(21) Appl. No.: 13/877,227

(22) PCT Filed: Nov. 7, 2011
(86) PCT No.: PCT/US11/59532

§ 371 Date: Apr. 1, 2013

Related U.S. Application Data
(60) Provisional application No. 61/412,975, filed on Nov. 12, 2010.

(51) Int. Cl. B05D 1/36

(52) U.S. Cl. CPC B05D 1/36
USPC 428/172; 427/265; 427/552; 249/115; 428/156

(57) ABSTRACT

A simple and practical method that can reduce the feature size of a patterned structure bearing surface hydroxyl groups is described. The patterned structure can be obtained by any patterning technologies, such as photo-lithography, e-beam lithography, nano-imprinting lithography. The method includes: (1) initially converting the hydroxyl or silanol-rich surface into an amine-rich surface with the treatment of an amine agent, preferably a cyclic compound; (2) coating an epoxy material on the top of the patterned structure; (3) forming an extra layer when applied heat via a surface-initiated polymerization; (4) applying an amine coupling agent to regenerate the amine-rich surface; (5) coating an epoxy material on the top of the patterned structure to form the next layer; (6) repeating step 4 and 5 to form multiple layers; This method allows the fabrication of feature sizes of various patterns and contact holes that are difficult to reach by conventional lithographic methods.

### CROSS-REFERENCE TO RELATED APPLICATIONS

NONE

### STATEMENT REGARDING FEDERALLY SPONSORED RESEARCH

NONE

### BACKGROUND OF THE INVENTION

As the size of the manufactured structures reached the nanoscale domain, photolithography started facing several technical, economical and physical challenges. For instance, photolithography presents physical constraints due to wavelength diffraction issues that preclude the fabrication of ultra-small size structures. In addition, the price of equipment and facilities is becoming prohibitively expensive. Technologies under development, such as NIL and SFIL molding techniques, would appear to provide methods for patterning large areas with low cost and high throughput; however, molding requires original master molds, which are normally fabricated by lithographic methods, which suffers from conventional limitations. Another method based on electron beam lithography, named “molecular ruler,” enables creation of metallic structures as small as 30 nm; however, since this technique relies on a layer-by-layer deposition, it is laborious and time consuming. A similar approach includes the growing of polymeric brushes on different types of patterned polymers by atom transfer radical polymerization (ATRP) to control imprinted structures sizes, but this process is slow (4 to 16 hours depending on the monomers used). Another approach is sealing and oxidative shrinking processes, which can create sub-10 nm channels; however, this method requires expensive laser set-ups and high oxidative temperatures. Yet another technique, named self-perfection by liquefaction (SPEL), has been useful to create small nanostructures; however, it requires a difficult-to-achieve perfect conformal contact between a guiding plate and its target, and the resulting structures' dimensions are controlled by polymer reflow which can be difficult to accurately control. Finally, shadow evaporation has also been used to shrink grating gap sizes down to 10 nm but the generation of sharp profiles has not yet been demonstrated.

Thus, there remains an unmet need for effective ways to reduce the feature sizes that are difficult to reach by conventional lithographic methods.

### BRIEF SUMMARY OF THE INVENTION

A simple and practical method that can reduce the feature size of a patterned structure bearing surface hydroxyl groups is described. The patterned structure can be obtained by any patterning technologies, such as photo-lithography, e-beam lithography, or nano-imprinting lithography. The method includes: (a) creating patterned structure on a layer bearing surface hydroxyl groups; (b) treating the surface of the patterned layer with an amine-containing agent to convert the hydroxyl groups into amine groups; (c) reacting an epoxysilicone material with the amine groups on the top of the patterned layer; (d) forming a second layer by a surface-initiated polymerization of the epoxy material; (e) applying a di-amine coupling agent; (f) repeating steps (c) through (e) to form multiple layers. This method allows the fabrication of feature sizes of various patterns and contact holes that are difficult to reach by conventional lithographic methods.

### BRIEF DESCRIPRTION OF THE DRAWINGS

FIG. 1. A schematic of preparation of a molecular layer on imprinted film.

FIG. 2. A schematic for stepwise sequences for building molecular layers on surface of patterned structures.

FIG. 3. Molecular layer thickness according to the number of layers.

FIG. 4. Molecular layer thickness according to the oligomer size.

FIG. 5. SEM showing cross sections of SSQ patterns.

FIG. 6. SEM showing the created patterns.

FIG. 7. SEM showing SSQ patterns imprinted with modified SiO2 mold.

FIG. 8. SEM showing SSQ patterns imprinted with dimensionally modified mold.

FIG. 9. SEM showing reduction of contact holes.

### DETAILED DESCRPTION OF THE INVENTION

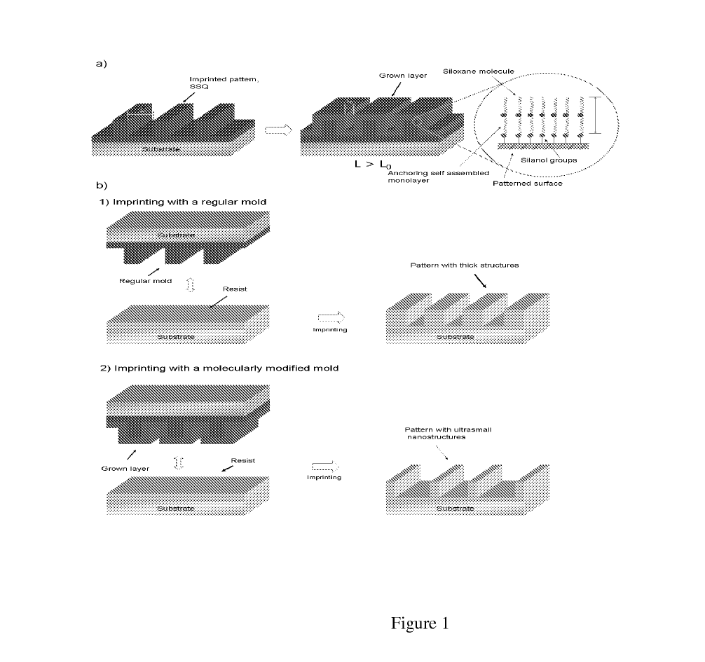

The present invention pertains to producing nanoscale features. A precise and controlled nanostructure fabrication through the structural molecular modification of patterned templates was developed. The fundamental principle of this method is to grow one or more molecular layer(s) with a controlled thickness on top of an imprinted film, as represented in FIG. 1. The initial layer, or the substrate itself in certain embodiments, bearing a pattern, contains surface hydroxyl groups which are reacted with amine agents and converted to amines. The amine-rich surface reacts with epoxy groups when epoxy polymer is introduced. The introduced epoxy polymer forms an overlay on the initial layer or the substrate, faithfully tracing the pattern on the initial layer or the substrate, respectively. The molecularly modified pattern is then surface treated and used as a device or a mold to replicate ultrasmall size nanostructures.

The technology of the present invention applies to any substrate surface containing functional silano or hydroxyl groups, and any substrate covered by polymer film containing functional silano or hydroxyl groups. Thus, in one embodiment of the invention, the substrate is glass or silica. In one embodiment of the invention, where a substrate is treated with suitable materials to create an initial imprinted film containing silano or hydroxyl group, any substrate known in the art for the production of a micro/nanoscale device can be used. Examples are: silicon wafers, glass, plastic films, metals, including copper, aluminum, etc.

For the initial imprintable film, i.e. the pattern layer, any common materials such as any silanol-rich SSQ resin, Si, SiO₂, SiₓN_{y}, and Cr can also be employed as long as that it contains hydroxyl functional groups on the surface. In one embodiment of the present invention, silsesquioxane resins (SSQs) are used to make the pattern layer. In a particular embodiment, the pattern layer is made with a photocurable silsequioxane (SSQ) material.

For example, the UV-patterning SSQ material, T^{Ph}_{0.40}T^{Methacryloxy}_{0.60}, with 0.40 molar ratio of methyl methacrylate groups required for photocuring and 0.60 molar ratio of phenyl groups for mechanical integrity, contains about 4% silanol group in the resin, as determined by ²⁹Si-NMR. Other SSQ materials, made by methods known in the art such as acid or base catalyzed hydrolysis of chlorosilanes or alkoxysilanes, can all be used to create a pattern layer. Examples also include any known silicone resin-based photoresist materials, epoxysilicone resins, and vinylether functional silicone resins. The film is created by laying precursor molecules on the substrate by, for example, spin-coating, and curing, for example, by UV irradiation or heat.

Patterned structures are created on the hydroxyl- or silanol-bearing substrate or the pattern layer. The patterned structures can be made by any patterning technologies known in the art, such as photo-lithography, e-beam lithography, nano-imprinting lithography, etc. The patterns need not be extra-fine, and technologies known to date for microscale fabrication can be used.

The hydroxyl-rich (silanol-rich) patterned surface is then treated with an amine agent and the hydroxyl groups reacted to give amine-rich surface. The amine agent molecules are deposited onto the surface by vapor deposition, which allows them to easily travel inside the pattern pitch due to their small size and the lack of intermolecular forces in the vapor phase. In certain instances, dip coating processes may also be used.

In certain embodiments of the invention, the amine agents useful for this invention are cyclic compounds having a formula (1):

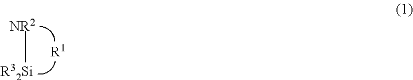

wherein R¹ is a C₃ or C₄ substituted or unsubstituted divalent hydrocarbon, R² is hydrogen, a C₁₋₆ linear or branched alkyl which is unsubstituted or substituted with amine, and R³ is independently a hydrogen or an alkyl or alkoxy. In some embodiments, R² is hydrogen, methyl, ethyl, propyl, isopropyl, butyl, or aminoethyl. In some embodiments, R³ is methyl, ethyl, methoxy, or ethoxy. All compounds having any combination of R¹, R², and R³ are contemplated for the use in the instant invention. More particularly, examples of cyclic silazanes are: N-methyl-aza-2,2,4,-trimethylsilacyclopentane (A), N-butyl-aza-2,2-methoxy-4-methylsilacyclopentane (B), N-methyl-aza-2,2,5-trimethylsilacyclohexane (C), and N-aminoethyl-aza-2,2,4-trimethylsilacyclopentane (D).

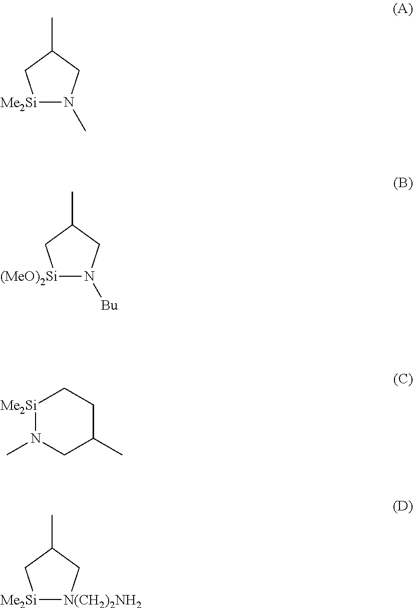

In certain other embodiments of the invention, amine agents are silanes containing an amine group having a formula (2):

R⁴HN—R⁵—Si—R⁶₃ (2)

wherein R⁴ is hydrogen, alkyl, aryl, carboxamide, or amine (—R⁷—NH₂), R⁵ is a divalent hydrocarbon or arylene, and R⁶ is alkoxy. In some embodiments, R⁴ is a methyl, ethyl, phenyl, or amine where R⁷ is —(CH₂)ₚ— wherein p is an integer from 1 to 6. In some embodiments, R⁵ is —(CH₂)_{q}—, wherein q is an integer from 1 to 6, or a divalent phenyl. In some embodiments, R⁶ is methoxy or ethoxy. All compounds having any combination of R⁴, R⁵, R⁶ and R⁷ are contemplated for the use in the instant invention.

Examples include, but are not limited to, the following compounds:

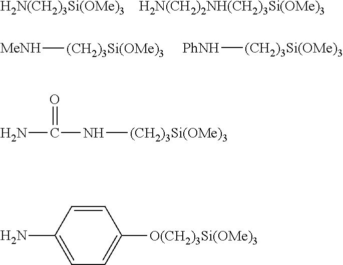

Next, an epoxy based polymer is grown on the top of the patterned film through an anchoring silylamine monolayer. The epoxy material useful to practice this invention is any epoxy-containing chemicals and polymers, and including siloxane based materials (epoxysilicones).

An epoxysilicone useful to practice the instant invention has a general formula

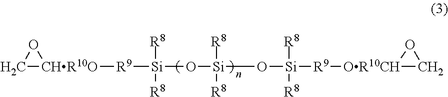

wherein R⁸ independently represents a hydrogen or C₁₋₄ alkyl, R⁹ and R¹⁰ each is optionally present, and when present, independently represents C₁₋₆ divalent hydrocarbon, and n is an integer between 0 and 1000. In some embodiments, R⁸, R⁹, and R¹⁰ are unsubstituted. In some embodiments, each R⁸, R⁹, and R¹⁰ are substituted. In certain embodiments, n is between 1 and 1000, and may be any and all integers between 1 and 1000. Therefore, the molecular weight of the epoxysilicone may be more than or equal to 142 up to about 100,000 g/mole. In some embodiments, the molecular weight of the epoxysilicone is, by way of example, 500, 1000, 2000, 3000, 4000, 5000, 6000, 7000, 8000, 9000, 10000, 20000, 40000, 60000, 80000, 100000 g/mole. These numbers illustrate the exemplary embodiments, and the invention covers epoxysilicone of all molecular sizes in the range.

Alternatively, the epoxy group is epoxycyclohexylethyl group, and some compounds useful for practicing the instant invention have the general formula:

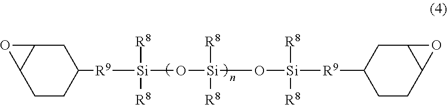

wherein n, R8 and R9 are as described above.

An example of epoxysilicone is epoxypropoxypropyl-terminated polydimethylsiloxane (PDMS) polymer.

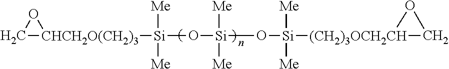

An example of epoxysilicone that is an epoxycyclohexylethyl compound is shown below.

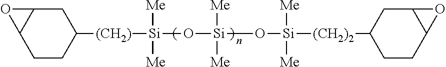

In either of the formula above, n is an integer between 0 and 1000.

In certain embodiments, one or more R⁸ is an alkyl terminally substituted with an epoxy group. If an epoxysilicone polymer with more than two epoxy groups (functionality≧3) is used as the epoxy growing layer, a hyperbranched molecular brush would be formed on the surface (Ref.: Sunder, A.; Heinemann, J.; Frey, H. Chem. Eur. J. 2000, 6, 2499-2506). In this manner, a series of sequentially repeated coating steps can lead to the formation of coating layers with any desired thickness, and thus creating any gap size from few hundreds to only tens of nanometers.

The molecular layers are grown on the patterns by using either vapor deposition or dip coating processes. The thickness of the resulting molecular monolayer is predictable and reproducible, allowing a precise reduction of the space between protrusions. These processes allow the epoxysilicone molecules to enter into the pattern trenches without apparent size limitations. Even an epoxysilicone polymer with a higher molecular weight (such as 79,000) can penetrate inside reduced pattern trenches (55 nm) by capillary forces. Thus, the method of instant invention may be used to construct structures with any desired dimensions, having features smaller than by prior art methods.

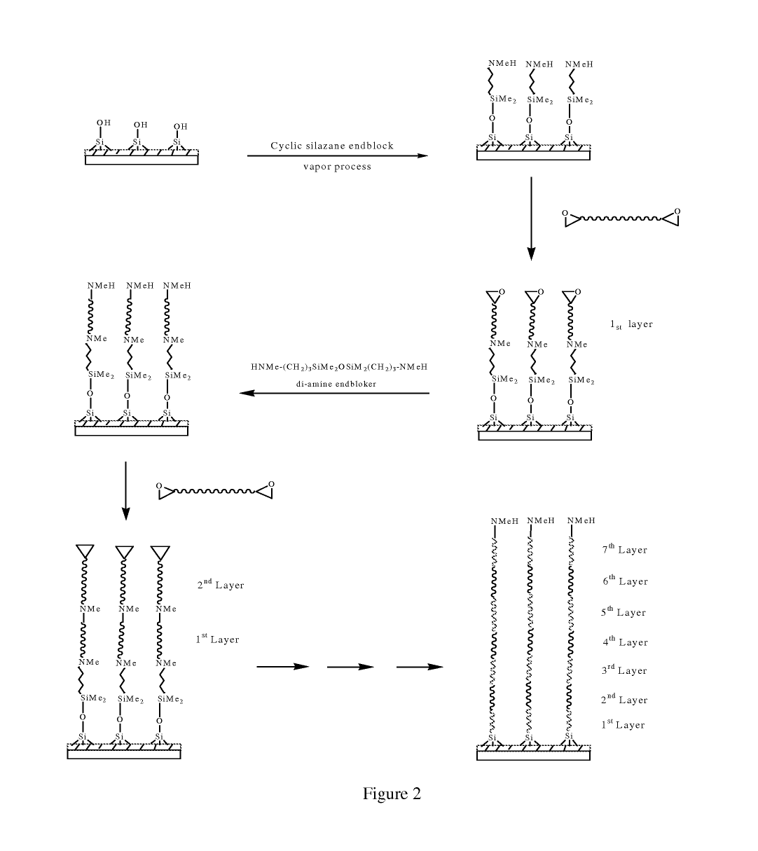

Further, in certain embodiments of the invention, vertically extended multiple layers are grown controllably on the top of the original layer using a di-amine coupling agent, which converts the epoxy enriched surface at the end of the first reaction back into an amine-function-rich surface. The trenches can be further reduced in size by adding thicker layers of the epoxy materials. Examples of the coupling agents are 1,3-bis (N-methyl aminoisobutyl) tetrmethyldisiloxane, and aminopropyl terminated polydimthylsiloxane. This sequential coating process works well only for lower molecular weight reactive polymers (<10000 g/mol). When a larger molecular weight polymer is employed, steric hindrance impedes the reaction between the reactive groups and the second silylamine layer. By vertically extended it is meant that the additional epoxy materials are covalently bound to the amine groups and extend the previously laid down epoxy polymer materials in a manner generally perpendicular to the substrate pattern surface. The epoxy polymer materials may or may not be horizontally bonded. By layer it is meant that each additional coating of epoxy polymer materials can be distinguished from the previous coating in a manner illustrated in FIG. 2, last panel. The resulting multilayer material comprises linear polymers extending generally perpendicular to the substrate pattern surface at the point where the polymer is attached to the surface, and not to the whole shape of the substrate. Therefore, if a pattern comprises a trench, for example, a polymer may be generally perpendicular to the wall of a trench.

Finally the un-reacted or non-anchored siloxane polymers are removed using organic solvents to reveal a patterned structure with enhanced protrusion dimensions, and conversely, reduced space between the protrusions. Because the molecular layers follow the original pattern contour with great precision, sharp definitions are easily achieved.

FIG. 2 depicts the steps to grow the molecular layers using SSQ as the initial layer. First, the UV-curable SSQ resist was patterned via a photo-NIL process to form the desired structures. Next, the surface of the patterned structure was treated with a novel cyclic silazane by a vapor deposition process. At the initial surface treatment, the hydroxyl or silanol groups on the patterned surface are readily transformed into an amine groups via a hydrolytically stable Si—O—Si linkage, by reacting, for example, with a cyclic azasilane compound, N-methyl-aza-2,2,4,-trimethlsilacyclopentane creating an amine-enriched surface (I) (eq. 1).

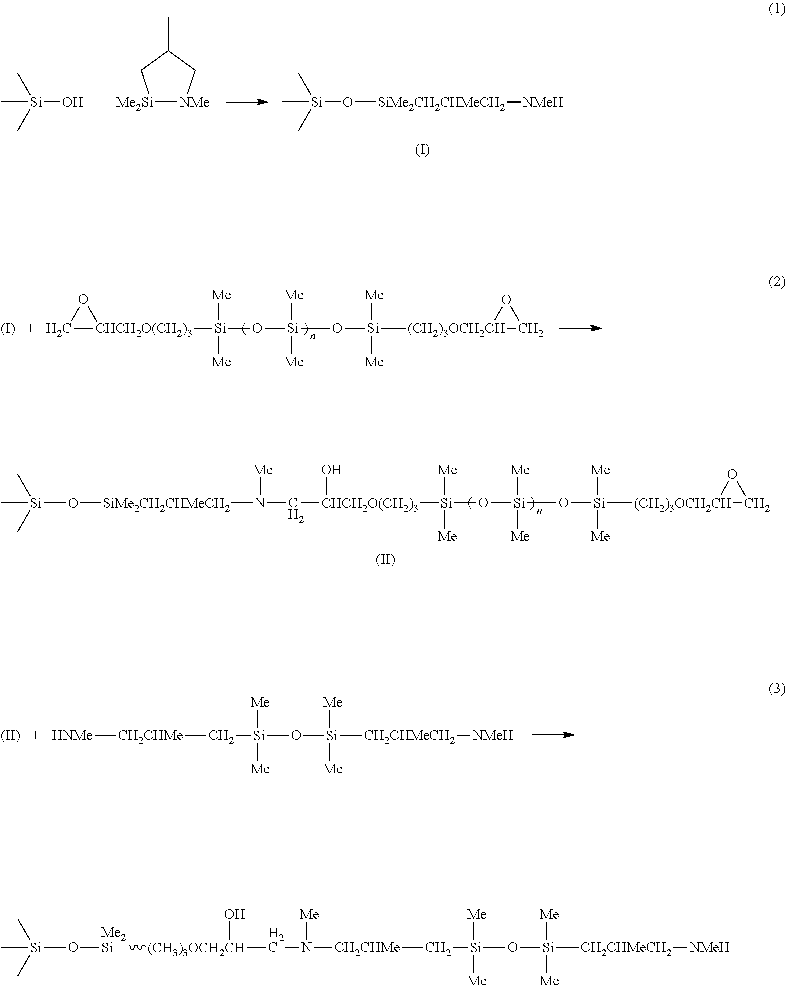

The amine-enriched surface (I) is then coated with an epoxy polymer, more particularly an epoxysilicone polymer, for example, epoxypropoxypropyl terminated polydimethylsiloxane (PDMS) polymer, whereby the amine groups react with the epoxy group to form strong covalent bonds, in this example, —CH₂—N(Me)— CH₂—CH(OH)—CH₂—, linking the PDMS polymer chain on the patterned surface. Multiple layers are grown controllably on the top of the original layer using a di-amine coupling agent to regenerate the amine-enriched surface. The other epoxy group of the PDMS chain end (II) can be further treated with 1,3-bis (N-methyl aminoisobutyl) tetrmethyldisiloxane to regenerate an amine-enriched surface (III) (eq. 3).

The created nanostructures may further be modified by several means such as reactive ion etching, which, due to the exceptional etching properties of the patterning silsesquioxane layers, allows the fabrication of small nanostructures in silicon or silicon dioxide layers. Reactive ion etching is known in the art and can be carried out under standard conditions.

One aspect of the invention is the fabrication of nanoscale devices. The method described above can readily be adapted to manufacture devices needing nanoscale features.

Further, functional materials can be used to build the layers. For instance, membranes with uniform and controlled pore size for molecular separations and ultra-small nano-channels could be easily constructed. Functional SSQ nanoimprint lithography (NIL) resist layers with capabilities beyond an easy patterning can be employed. The techniques here presented can be used for several advanced applications such as the engineering of membranes with nanopore structures for molecular separations (see Example 8) and the direct fabrication of structures on silicon based materials for the next-generation CMOS devices. In addition, SSQs' high SiO content make them highly stable to O₂ plasma etching so the patterns surface chemistry can easily be modified without generating any structural damaged to the patterned structures. Further, a low surface releasing layer (for example, a fluorisilane monolayer) can be built on the top of a mold to infuse it with superior release properties.

Another aspect of the invention is the fabrication of molds for micro- and nanoscale devices. SSQs are known to have outstanding characteristics as stamps for nanoimprinting, and the molds prepared by the above described method can readily be used to transfer the patterns to other types of polymer films. In this fashion, NIL stamps for actual nanoscale replication are engineered without the need to rely on other more expensive and low throughput techniques.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. All percentages are in wt. %.

### Example 1

A SSQ resin, T^{Ph}_{0.40}T^{Methacryloxy}_{0.60}, containing about 4% mole of silanol, was spin-coated on a 4″-silicon wafer, and cured under UV-irradiation (UV broadbank dosage+0.3 J/cm²) at room temperature. The coating surface was treated with N-methyl-aza-2,2,4,-trimethlsilacyclopentane by a vapor deposition process. Next, an epoxypropoxypropyl-terminated polydimethylsiloxane (PDMS) polymer (Mn: 8000, M_{w}/Mₙ=2.05) was applied to the amine-enriched surface by spin coating. Additional layers of the epoxysilicone polymer were applied by first treating the preceding layer with 1,3-bis (N-methyl aminoisobutyl) tetrmethyldisiloxane, followed by an epoxypropoxypropyl-terminated polydimethylsiloxane (PDMS) polymer (Mn: 8000, M_{w}/Mₙ=2.05). The thickness of the coating on the top of the SSQ resin was measured by ellipsometry after each layer of the epoxysilicone is anchored to the surface.

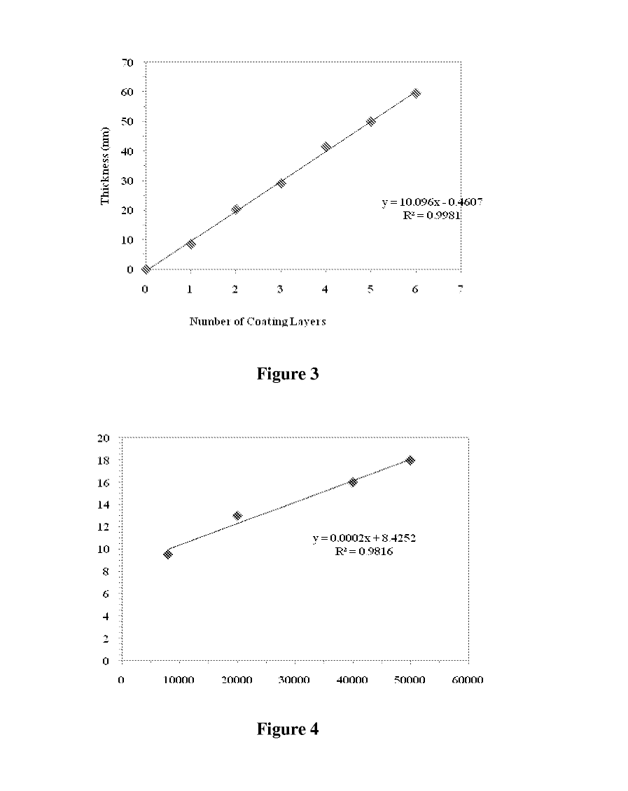

FIG. 3 shows that the thickness of the coating layer increases linearly with the number of coating for the polymer of this size, and each layer is approximately about 10 nm in thickness.

### Example 2

A 4″-silicon wafer is treated similarly to Example 1, except that epoxy polymers having different molecular weights were coated once. FIG. 4 shows that the thickness of the coating layer increases substantially linearly with the increase in molecular weight of the epoxy polymers.

### Example 3

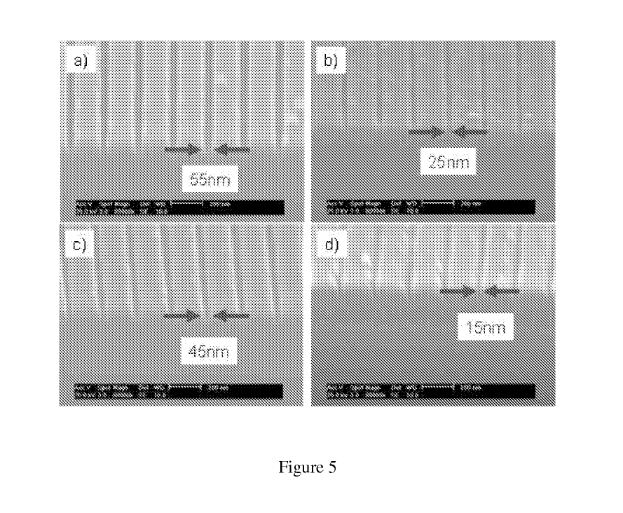

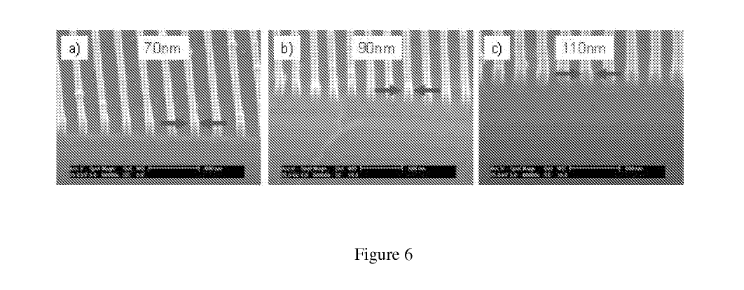

High resolution nanostructure fabrication was demonstrated using this technique by reducing the gap between dense lines to less than 30 nm. FIG. 5 is a scanning electron micrograph (SEM) showing the surface of the pattern. The trench size of a SSQ grating pattern was reduced with the deposition of several molecular layers, and the gap size decreased almost linearly with the number of layers coated (Mn=8000 g/mol, M_{w}/Mₙ=2.05). The original pattern (FIG. 5a) had trenches with widths of 55 nm, and after three layers were coated, the width of the trench was reduced to about 25 nm, (FIG. 5b), each layer having reduced the gap by 10 nm.

### Example 4

The same 55 nm trench pattern as in Example 3 was modified using macromolecules with differing molecular weight. When an epoxypropoxypropyl terminated polydimethylsiloxane (PDMS) polymer of a molecular weight of 8000 g/mol (M_{w}/Mₙ=2.05) was employed, the trench size was reduced to 45 nm (FIG. 5c). A 79 000 g/mol molecular weight polymer (M_{w}/Mₙ=2.10) reduced the trench size to 15 nm (FIG. 5d). The results of Examples 3 and 4 are in concordance with the measurements presented in FIGS. 3 and 4, respectively.

### Example 5

The fidelity of the growing molecular layers to the shape contour of the patterned structures was demonstrated. Experiments were carried out essentially as in Example 1. Four layers of epoxysilicone polymers were laid down on top of an SSQ grating to increase the line width from 70 nm to 110 nm. After removing the un-anchored material, the structure profile remained unaffected, simply smaller. (FIG. 6).

### Example 6

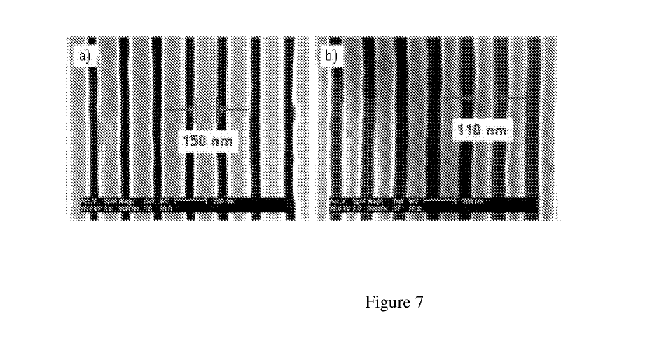

SSQ and SiO₂ molds with trenches narrower than originally patterned were prepared. The molds were used to imprint a SSQ pattern with thinner line widths. SEM of SSQ patterns imprinted with the original mold and with line width modified molds are shown in FIGS. 7a and b; the space width was decreased from 150 nm to 110 nm after 4 epoxysilicone layers [Mn=8000 g/mol, M_{w}/Mₙ=2.05] were grown. In the same manner, the trench of a SSQ grating mold was reduced from 85 nm to 45 nm after depositing 5 molecular layers.

### Example 7

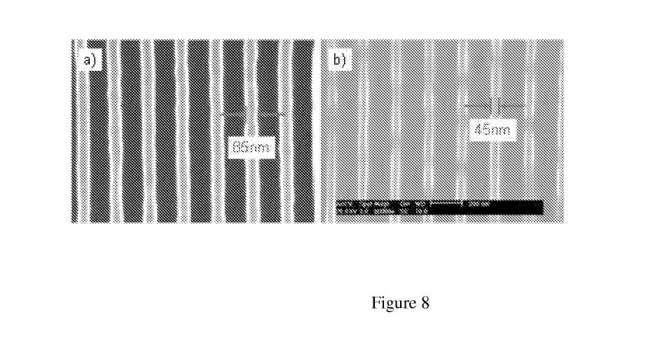

The mold prepared according to Example 6 was used to pattern a SSQ resist by a UV curing process. The imprinted SSQ resist is presented in FIG. 8.

### Example 8

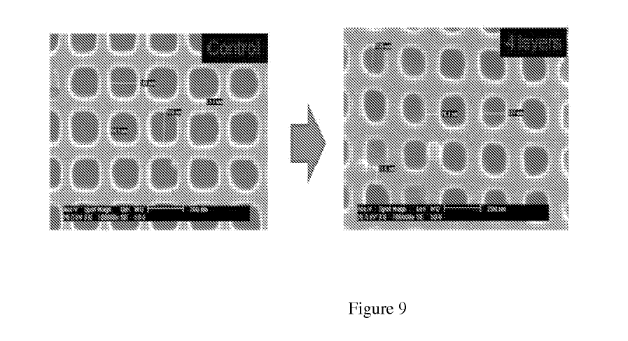

Structures other than linear trenches can also be created. FIG. 9 shows the reduction of contact hole array by growing the molecular layers inside of the hole.

1. A method to fabricate a device having a reduced feature size of a patterned structure or contact holes comprising the steps of:
a) creating patterned structure on a layer bearing surface hydroxyl groups;
b) treating the surface of the patterned layer with an amine agent to convert the hydroxyl groups into amine groups;
c) coating an epoxysilicone material on the top of the pattern layer; and
d) forming a second layer by a surface-initiated polymerization of the epoxy polymer material with amine groups,
thereby reducing the size of a feature of the patterned structure.

2. The method according to claim 1 further comprising the steps of:
e) applying a di-amine coupling agent;
f) coating an epoxy polymer material on the top of the molecular layer;
g) forming an epoxy polymer layer by a surface-initiated polymerization of the epoxy polymer material; and
h) repeating steps (e) through (g) one to hundred times to form vertically extended multiple epoxy polymer layers.

3. The method according to claim 1, wherein the amine agent is a cyclic compound having a formula (1): 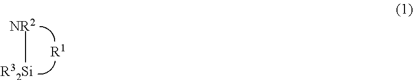
wherein R¹ is a C₃ or C₄ substituted or unsubstituted divalent hydrocarbon, R² is hydrogen, a C₁₋₆ linear or branched alkyl which is unsubstituted or substituted with amine, and R³ is independently a hydrogen or an alkyl or alkoxy.

4. The method according to claim 3, wherein each R³ is selected independently from methyl, ethyl, methoxy, and ethoxy.

5. The method according to claim 3, wherein R² is selected from hydrogen, methyl, ethyl, propyl, isopropyl, butyl, and aminoethyl.

6. The method according to claim 3 wherein the cyclic compound is selected from the group consisting of

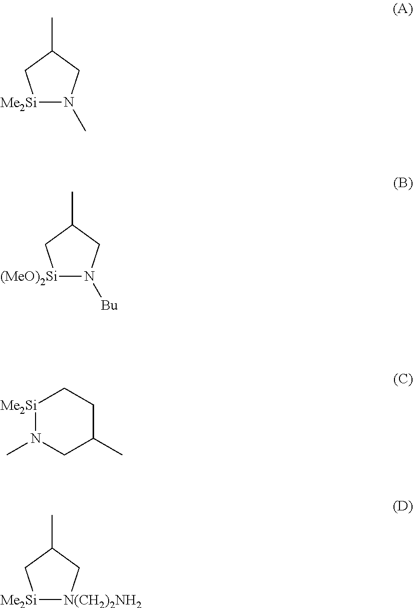

7. The method according to claim 1, wherein the amine agent is a linear silane containing an amine group having a formula (2):
R⁴HN—R⁵—Si—R⁶₃ (2)
wherein R⁴ is hydrogen, alkyl, aryl, carboxamide, or amine (—R⁷—NH₂), R⁵ is a divalent hydrocarbon or arylene, and R⁶ is alkoxy.

8. The method according to claim 7, wherein R⁴ is a methyl, ethyl, phenyl, or amine where R⁷ is —(CH₂)ₚ— wherein p is an integer from 1 to 6, R⁵ is —(CH₂)_{q}—, wherein q is an integer from 1 to 6, or a divalent phenyl, and R⁶ is methoxy or ethoxy.

9. The method according to claim 7, wherein the amine agent is selected from

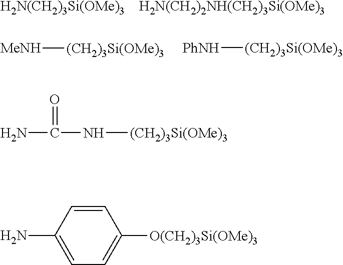

10. The method according to claim 1, wherein the patterned structure or the contact holes are prepared by photo-lithography, e-beam lithography, or nano-imprinting lithography.

11. The method according to claim 1, wherein the epoxy polymer material has molecular weight less than 10,000 g/mol.

12. The method according to claim 1, wherein the epoxy polymer material is an epoxysilicone material.

13. The method according to claim 12, wherein the epoxysilicone material has a formula (3) 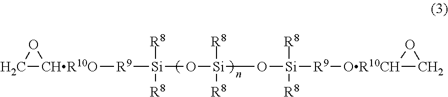
wherein R⁸ independently represents a hydrogen or substituted or unsubstituted C₁₋₄ alkyl, R⁹ and R¹⁰ each is optionally present, and when present, independently represents C₁₋₆ divalent hydrocarbon and n is an integer between 0 and 1000.

14. The method according to claim 13, wherein the epoxysilicone material is epoxypropoxypropyl terminated polydimethylsiloxane (PDMS) polymer.

15. The method according to claim 12, wherein the epoxysilicone material has a formula (4) 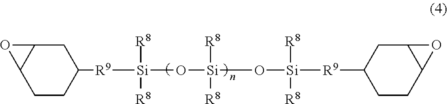
wherein R⁸ independently represents a hydrogen or substituted or unsubstituted C₁₋₄ alkyl, R⁹ is optionally present, and when present, independently represents C₁₋₆ divalent hydrocarbon and n is an integer between 0 and 1000.

16. The method according to claim 15, wherein the epoxysilicone material is

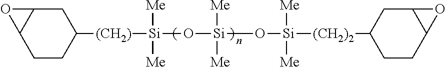

17. The method according to claim 1, wherein the degree of reduction of the size of the feature is controlled by selecting a desired chain length of the epoxy polymer material.

18. The method according to claim 2, wherein the degree of reduction of the size of the feature is controlled by selecting a desired number of layers of the epoxy polymer material.

19.-21. (canceled)

22. A device manufactured by a method according to claim 1.

23. A device mold manufactured by a method according to claim 2.

24. The device mold according to claim 23 wherein the last layer of the epoxy polymer material laid comprises a low surface releasing layer.

25. A device manufactured using the mold according to claim 23.
